(19) United States
(12) Patent Application Publication
(10) Pub. No.: US 2025/0332898 A1
(43) Pub. Date: Oct. 30, 2025

(54) VEHICLE LOWER PART STRUCTURE

(71) Applicant: TOYOTA JIDOSHA KABUSHIKI KAISHA, Toyota-shi (JP)

(72) Inventor: Katsuichiro HIRAKAWA, Toyota-shi (JP)

(73) Assignee: TOYOTA JIDOSHA KABUSHIKI KAISHA, Toyota-shi (JP)

(21) Appl. No.: 19/021,587

(22) Filed: Jan. 15, 2025

(30) Foreign Application Priority Data
Apr. 24, 2024 (JP) 2024-070366

(51) Int. Cl. B60K 1/04; B60R 22/22; B62D 25/20

(52) U.S. Cl. CPC B60K 1/04; B60R 22/22; B62D 25/20; B60K 2001/0438

(57) ABSTRACT

A vehicle lower part structure includes a battery case that houses a battery and is disposed at a lower portion of the vehicle, a vehicle body constituting portion that is a metal cast product and has a battery support portion that supports the battery case, and an anchor member that is attached to a vehicle upper side of the battery support portion.

### CROSS-REFERENCE TO RELATED APPLICATION

This application claims priority to Japanese Patent Application No. 2024-070366 filed on Apr. 24, 2024, incorporated herein by reference in its entirety.

### BACKGROUND

### 1. Technical Field

The present disclosure relates to a vehicle lower part structure.

### 2. Description of Related Art

A configuration in which a reinforcing member is provided at a part to which a seat belt anchor is attached in order to enhance rigidity against a tensile load input from a seat belt to the seat belt anchor is known in the related art (see Japanese Unexamined Patent Application Publication No. 2019-156088 (JP 2019-156088 A), for example).

### SUMMARY

However, providing the reinforcing member to enhance rigidity at the part to which an anchor member such as a seat belt anchor is attached may lead to an increase in weight and an increase in manufacturing cost of a vehicle.

Thus, an object of the present disclosure is to obtain a vehicle lower part structure capable of improving rigidity against a load input to an anchor member while suppressing an increase in weight and an increase in manufacturing cost of a vehicle.

In order to achieve the above object, a vehicle lower part structure according to a first aspect of the present disclosure includes:
a battery case that accommodates a battery and is disposed at a lower part of a vehicle;
a vehicle body constituting portion that is a cast product of metal and includes a battery support portion that supports the battery case; and
an anchor member that is attached to the battery support portion on a vehicle upper side.

According to the disclosure of the first aspect, the battery case that accommodates the battery is disposed at the lower part of the vehicle, and the vehicle body constituting portion that is a cast product of metal includes the battery support portion that supports the battery case. Also, the anchor member is attached to the battery support portion on the vehicle upper side. Here, since the battery case that accommodates the battery is heavy, a load directed to the vehicle lower side constantly acts on the battery support portion.

Therefore, even if a load directed to a vehicle front side, for example, is input to the anchor member, and the load directed to the vehicle front side is transmitted to the battery support portion via the anchor member, the battery support portion easily withstands the load. In other words, according to the present disclosure rigidity against a load input to the anchor member is improved while an increase in weight and an increase in manufacturing cost of the vehicle are suppressed.

Also, according to a vehicle lower part structure of a second aspect of the present disclosure, in the vehicle lower part structure of the first aspect, the battery support portion includes a vertical wall portion that extends in a vertical direction, a horizontal wall portion that extends in a horizontal direction from a lower end portion of the vertical wall portion, the battery case being attached to the horizontal wall portion, and a reinforcing rib that establishes coupling between the vertical wall portion and the horizontal wall portion and reinforces the vertical wall portion and the horizontal wall portion, in a side view.

According to the disclosure of the second aspect, the battery support portion includes the vertical wall portion that extends in the vertical direction, the horizontal wall portion that extends in the horizontal direction from the lower end portion of the vertical wall portion, the battery case being attached to the horizontal wall portion, and the reinforcing rib that establishes coupling between the vertical wall portion and the horizontal wall portion and reinforces the vertical wall portion and the horizontal wall portion, in a side view. Rigidity of the battery support portion is thus improved.

Also, according to a vehicle lower part structure of a third aspect of the present disclosure, in the vehicle lower part structure of the first or second aspect, the vehicle body constituting portion has a cross member that extends in a vehicle width direction with the cross member spaced apart from the battery support portion, and the cross member, the battery support portion, and the battery case form a rahmen structure in a side view.

According to the disclosure of a third aspect, the vehicle body constituting portion includes the cross member that extends in the vehicle width direction with the cross member spaced apart from the battery support portion. Also, the cross member, the battery support portion, and the battery case form the rahmen structure in a side view. Therefore, rigidity of the vehicle body lower part is effectively secured. Note that the “rahmen structure” in the present disclosure also includes a “substantially rahmen structure.”

Moreover, according to a vehicle lower part structure of a fourth aspect of the present disclosure, in the vehicle lower part structure according to any one of the first to third aspects, the anchor member is attached to the battery support portion on the vehicle upper side by a fastening member.

According to the disclosure of the fourth aspect, the anchor member is attached to the battery support portion on the vehicle upper side by the fastening member. Therefore, in a case where the anchor member is not attached through fastening, a load input to the anchor member is effectively received by the battery support portion as compared with a case where the anchor member is bonded with an adhesive, for example.

Also, according to a vehicle lower part structure of a fifth aspect of the present disclosure, in the vehicle lower part structure according to the fourth aspect, the anchor member is a seat belt anchor.

According to the disclosure of the fifth aspect, the anchor member is the seat belt anchor. Therefore, even if a load directed to the vehicle front side is input to the seat belt anchor at the time of front collision or the like of the vehicle, the load is effectively received by the battery support portion.

Also, according to a vehicle lower part structure of a sixth aspect of the present disclosure, in the vehicle lower part structure of the fifth aspect, the seat belt anchor is for a rear seat seat belt.

According to the disclosure of the sixth aspect, the seat belt anchor is for the rear seat seat belt. Therefore, even if a load directed to the vehicle front side is input to each seat belt anchor by two passengers who are seated in the rear seat, for example, at the time of front collision or the like of the vehicle, each load is effectively received by the battery support portion.

As described above, according to the present disclosure, it is possible to improve rigidity against a load input to the anchor member while suppressing an increase in weight and an increase in manufacturing cost of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view showing a vehicle lower part structure according to the present embodiment;

FIG. 2 is a schematic side view showing a vehicle lower part structure according to the present embodiment;

FIG. 3 is a schematic perspective view showing a rear portion of a vehicle body constituting a vehicle lower part structure according to the present embodiment; and

FIG. 4 is a schematic plan view illustrating a rear portion of a vehicle body constituting the vehicle lower part structure according to the present embodiment.

### DETAILED DESCRIPTION OF EMBODIMENTS

Hereinafter, an embodiment according to the present disclosure will be described in detail with reference to the drawings. For convenience of description, the arrow UP, the arrow FR, and the arrow RH appropriately shown in the figures indicate the upward direction of a vehicle, the forward direction of the vehicle, and the right direction of the vehicle, respectively. Therefore, in the following description, when the vertical, front-rear, and left-right directions are described without special mention, it is assumed that the vertical direction of the vehicle, the front-rear direction of the vehicle front-rear direction, and the left-right direction (vehicle width direction) of the vehicle are indicated.

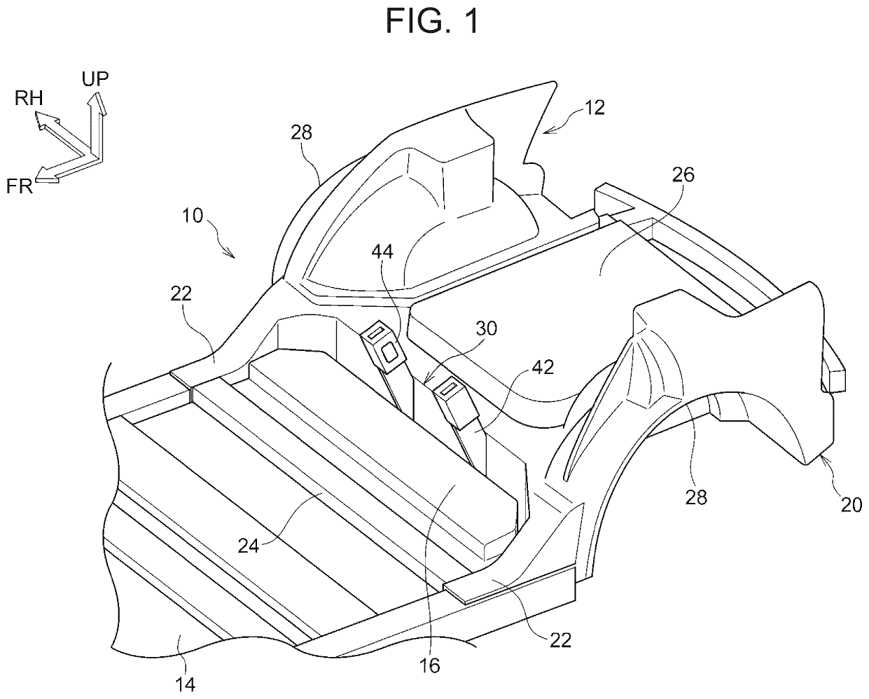

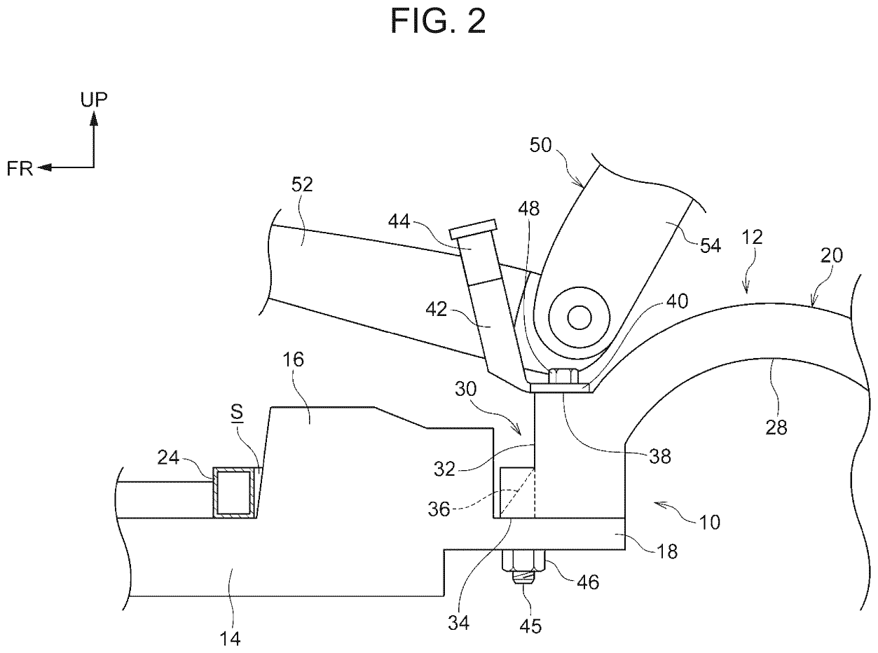

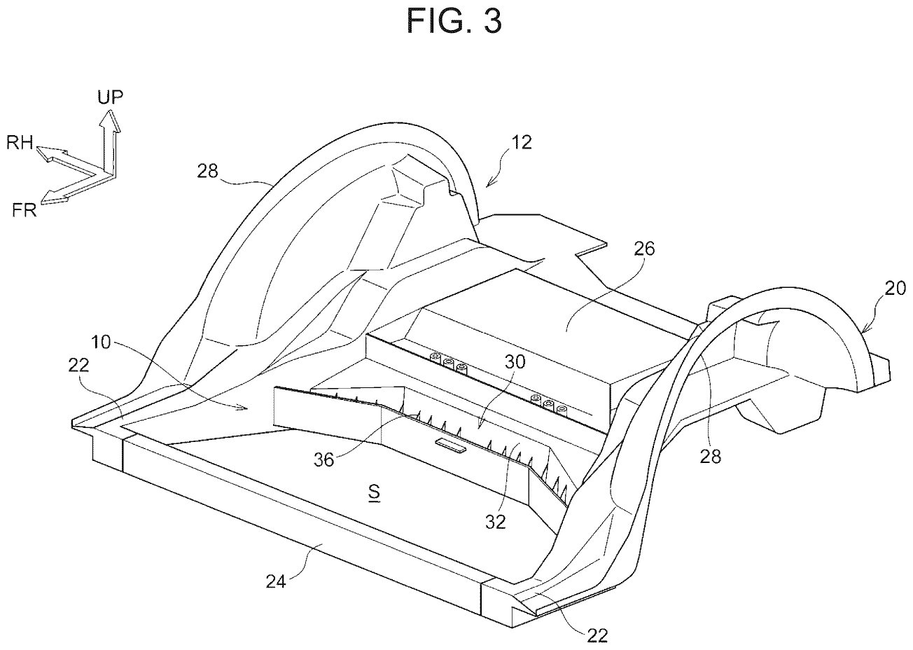

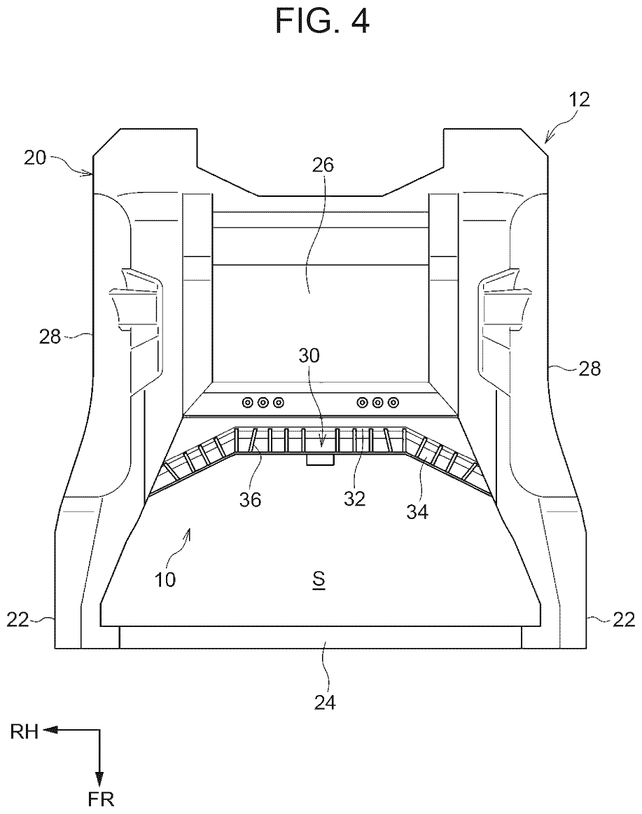

As shown in FIGS. 1 and 2, the vehicle 12 including the vehicle lower part structure 10 according to the present embodiment is a battery electric vehicle or a hybrid electric vehicle (plug-in hybrid electric vehicle) in which a battery case 14 is disposed at a lower part thereof. The vehicle 12 including the vehicle lower part structure 10 has a vehicle body rear portion 20 as a vehicle body constituting portion constituting a rear portion of the vehicle body. As shown in FIGS. 3 and 4, the vehicle body rear portion 20 is a cast product called a gigacast product in which a plurality of parts is integrally molded with a metal such as an aluminum alloy.

Note that the front portion of the vehicle body (not shown) constituting the front portion of the vehicle body is a similar cast product, and a battery case 14 having a substantially rectangular flat shape and accommodating a battery which is a heavy object is disposed on the lower side between the front portion of the vehicle body and the rear portion 20 of the vehicle body. That is, the vehicle 12 in the present embodiment has a configuration in which the vehicle body front portion and the vehicle body rear portion 20 are connected by the battery case 14.

Specifically, only the vehicle body rear portion 20 will be described. As shown in FIGS. 3 and 4, bilaterally symmetrical extending portions 22 extending in a predetermined length toward the front side are integrally formed on both left and right sides of a battery support portion 30, which will be described later, of the vehicle body rear portion 20. A cross member 24 having a closed cross-sectional shape and extending in the vehicle width direction is integrally installed at a front end portion of the pair of extending portions 22.

That is, the cross member 24 is spaced apart from the battery support portion 30 toward the front side, and an opening S having a predetermined size is formed between the cross member 24 and the battery support portion 30. The protrusion 16 (see FIGS. 1 and 2) formed on the upper surface of the rear portion of the battery case 14 is inserted into the opening S from the lower side. A rear end portion 18 (see FIG. 2) extending rearward of the protrusion 16 is bolted and fixed to the battery support portion 30.

As illustrated in FIGS. 1 to 4, a wheel house 28 having a symmetrical shape capable of accommodating left and right rear wheels is integrally formed at an outer end portion in the vehicle width direction on the rear side with respect to the extending portion 22 of the vehicle body rear portion 20. A floor portion 26 constituting a bottom wall of the luggage compartment is integrally formed between the wheel houses 28 of the vehicle body rear portion 20. A battery support portion 30 that supports the battery case 14 is formed on the front side of the floor portion 26 (the front end portion excluding the cross member 24 and the extending portion 22).

As shown in FIGS. 2 to 4, the battery support portion 30 includes a vertical wall portion 32 extending in a vertical direction, a horizontal wall portion 34 extending in a horizontal direction from a lower end portion of the vertical wall portion 32, and a plurality of reinforcing ribs 36 in a side view. The plurality of reinforcing ribs 36 couple between the vertical wall portion 32 and the horizontal wall portion 34 to reinforce the vertical wall portion 32 and the horizontal wall portion 34. Each of the reinforcing ribs 36 has a flat plate shape formed in a substantially right-angled triangle shape in a side view, and is provided at a predetermined interval in a substantially vehicle width direction.

A bolt insertion hole (not shown) is formed in each of the horizontal wall portions 34 between the reinforcing ribs 36. Then, as shown in FIG. 2, the rear end portion 18 of the battery case 14 is fastened by the bolt 45 inserted into each bolt insertion hole and the nut 46 screwed to the bolt 45. Accordingly, the rear end portion 18 of the battery case 14 is attached to the front end portion of the vehicle body rear portion 20 excluding the cross member 24 and the extending portion 22.

That is, the battery case 14 is supported in a state of being suspended by the battery support portion 30 formed at the front end portion of the vehicle body rear portion 20 excluding the cross member 24 and the extending portion 22. Thus, in a side view, the cross member 24, the battery support portion 30, and the battery case 14 form a substantially rigid frame structure.

Further, a flat seat belt anchor 40 as an anchor member is attached to a substantially central portion in the vehicle width direction of the upper wall portion 38 extending rearward from the upper end portion of the vertical wall portion 32 by a fastening member 48 at a predetermined interval in the vehicle width direction. The fastening member 48 is a bolt, a nut, or the like. The other end of the webbing 42 to which the buckle 44 is attached is attached to one end of the seat belt anchor 40.

Further, the seat belt anchor 40 is for a seat belt of the vehicle seat 50 in a rear seat that does not slide. Therefore, the seat belt anchor 40, i.e., the webbing 42 to which the buckle 44 is attached, is provided in two for the seat belt of the occupant seated on at least the left and right vehicle seats 50 of the rear seat, respectively. When the vehicle seat 50 is a bench seat, the webbing 42 to which the buckle 44 is attached and the seat belt anchor 40 are provided one more for the seat belt of the occupant seated in the center thereof.

Further, in FIG. 2, a seat cushion 52 of the vehicle seat 50 is disposed on the upper side of the battery support portion 30. Webbing 42, to which buckle 44 is attached, is shown to extend from the side of seat cushion 52 to the vehicle cabin. Here, the webbing 42 to which the buckle 44 is attached is actually arranged to extend from between the rear end portion of the seat cushion 52 and the lower end portion of the seat back 54 to the vehicle cabin.

Next, the operation of the vehicle lower part structure 10 according to the present embodiment configured as described above will be described.

As described above, the battery case 14 containing the battery is disposed in the lower portion of the vehicle 12, and the vehicle body rear portion 20, which is a metal cast product, has the battery support portion 30 that supports the rear end portion 18 of the battery case 14. A seat belt anchor 40 that supports the webbing 42 to which the buckle 44 is attached is attached by a fastening member 48 to an upper wall portion 38 that is an upper side of the battery support portion 30.

Here, since the battery case 14 accommodating the battery is a heavy object, a load is constantly applied to the battery support portion 30 toward the lower side. In other words, the battery support portion 30 is always pulled downward by the battery case 14 containing a heavy battery.

Therefore, for example, at the time of a front collision of the vehicle 12 or the like, the webbing 42 is pulled toward the front side (specifically, the front upper side) by an occupant (not shown) seated on the vehicle seat 50 of the rear seat and wearing the seat belt. As a result, even if the load toward the front side (specifically, the front upper side) is input to the seat belt anchor 40 and the load toward the front side (specifically, the front upper side) is transmitted to the battery support portion 30 via the seat belt anchor 40, the battery support portion 30 can easily withstand the load.

That is, the load input to the seat belt anchor 40 can be effectively received by the battery support portion 30 without providing a reinforcing member for increasing the rigidity. As described above, according to the vehicle lower part structure 10 of the present embodiment, it is possible to improve the rigidity with respect to the load input to the seat belt anchor 40 while suppressing or preventing an increase in weight and an increase in manufacturing cost in the vehicle 12 (while simplifying the vehicle body configuration in the vehicle 12).

In addition, the battery support portion 30 includes a vertical wall portion 32 extending in the vertical direction in a side view, a horizontal wall portion 34 extending in the horizontal direction from the lower end portion of the vertical wall portion 32 and to which the battery case 14 is attached, and a plurality of reinforcing ribs 36. The plurality of reinforcing ribs 36 couple between the vertical wall portion 32 and the horizontal wall portion 34 to reinforce the vertical wall portion 32 and the horizontal wall portion 34. Therefore, the rigidity of the battery support portion 30 can be improved, and the bearing capacity against the input load can be sufficiently secured.

Further, the vehicle body rear portion 20 has a cross member 24 that is spaced apart from the battery support portion 30 and extends in the vehicle width direction, and the cross member 24, the battery support portion 30, and the battery case 14 form a substantially ramen structure in a side view. Therefore, the rigidity of at least the lower portion of the vehicle body of the vehicle 12 can be effectively secured.

Further, the seat belt anchor 40 is attached to the upper wall portion 38 of the battery support portion 30 by the fastening member 48. Therefore, when the seat belt anchor 40 is not attached by the fastening member 48, it may be joined by, for example, an adhesive. As compared with this case, the load input to the seat belt anchor 40 can be effectively received by the battery support portion 30.

Further, the seat belt anchor 40 is for a seat belt of the vehicle seat 50 in a rear seat that does not slide. Therefore, even when a load is input by, for example, two occupants (not shown) at the time of a front collision of the vehicle 12 or the like, each load can be effectively received by one battery support portion 30. Here, the two occupants are seated on the vehicle seat 50 in the rear seat and are fitted with a seat belt. The load is a load toward the front side (specifically, the front upper side) of each seat belt anchor 40.

Although the vehicle lower part structure 10 according to the present embodiment has been described with reference to the drawings, the vehicle lower part structure 10 according to the present embodiment is not limited to the illustrated one, and can be appropriately changed in design without departing from the gist of the present disclosure. For example, the anchor member is not limited to the seat belt anchor 40, and may be a child seat anchor, a seat belt anchor capable of fixing a wheelchair, or the like, although not shown.

What is claimed is:

1. A vehicle lower part structure comprising:
a battery case that accommodates a battery and is disposed at a lower part of a vehicle;
a vehicle body constituting portion that is a cast product of metal and includes a battery support portion that supports the battery case; and
an anchor member that is attached to the battery support portion on a vehicle upper side.

2. The vehicle lower part structure according to claim 1, wherein the battery support portion includes a vertical wall portion that extends in a vertical direction, a horizontal wall portion that extends in a horizontal direction from a lower end portion of the vertical wall portion, the battery case being attached to the horizontal wall portion, and a reinforcing rib that establishes coupling between the vertical wall portion and the horizontal wall portion and reinforces the vertical wall portion and the horizontal wall portion, in a side view.

3. The vehicle lower part structure according to claim 2, wherein:
the vehicle body constituting portion has a cross member that extends in a vehicle width direction with the cross member spaced apart from the battery support portion; and
the cross member, the battery support portion, and the battery case form a rahmen structure in a side view.

4. The vehicle lower part structure according to claim 1, wherein the anchor member is attached to the battery support portion on the vehicle upper side by a fastening member.

5. The vehicle lower part structure according to claim 4, wherein the anchor member is a seat belt anchor.

6. The vehicle lower part structure according to claim 5, wherein the seat belt anchor is for a rear seat seat belt.
